(19) United States
(12) Patent Application Publication
(10) Pub. No.: US 2026/0154201 A1
(43) Pub. Date: Jun. 4, 2026

(54) SYSTEMS, METHODS, AND MEDIA FOR COMPUTER PROCESSING THAT LEVERAGES CACHE LINE INVALIDATION AND CRYPTOGRAPHY AT THE CACHE COHERENCY LEVEL

(71) Applicant: Trustees of Boston University, Boston, MA (US)

(72) Inventors: Renato Mancuso, Medford, MA (US); Shahin Roozkhosh, Boston, MA (US); Denis Marie R. Hoornaert, Garching (DE)

(21) Appl. No.: 19/391,320

(22) Filed: Nov. 17, 2025

Related U.S. Application Data
(60) Provisional application No. 63/721,676, filed on Nov. 18, 2024.

(51) Int. Cl. G06F 12/0817

(52) U.S. Cl. CPC G06F 12/0828; G06F 2212/621

(57) ABSTRACT

Techniques are provided for computer processing that leverages cache line invalidation and cryptography at the cache coherency level. A hardware agent may operate as a cache coherent manager with a CCI. The hardware agent may appear to the CCI as a typical cache, however the hardware agent monitors snoop requests issued by the CCI. The hardware agent can take over control of providing decrypted data to a CPU for a physical address monitored by the hardware agent. The hardware agent may also take over control of encrypting dirty data corresponding to a physical address monitored by the hardware agent. In an embodiment, instruction cache lines may include inserted instructions that cause the caches to invalidate cache lines corresponding to the physical address being monitored. Additionally, data cache lines may be invalidated based on inserted instructions or an invalidation command issued by the hardware agent.

### CROSS-REFERENCE TO RELATED APPLICATIONS

The present application claims the benefit of U.S. Provisional Patent Application Ser. No. 63/721,676, which was filed on Nov. 18, 2024, by Renato Mancuso for ZERO-TRACE DYNAMIC SECURE PROCESSING OF DATA AND USES THEREOF, which is hereby incorporated by reference.

### BACKGROUND

### Technical Field

The present disclosure relates generally to the cache coherency level of a computer architecture and more specifically to techniques for computer processing that leverages cache line invalidation and cryptography at the cache coherency level.

### Background Information

Caches, Memory Management Units (MMUs), and Translation Lookaside Buffers (TLBs) play pivotal roles in the execution flow of a computer system. Caches are small, fast memory stores that keep copies of frequently accessed data from the main memory. This proximity to the CPU speeds up data retrieval, improving overall system performance. The MMU is crucial in managing and translating virtual memory addresses to physical addresses. It ensures efficient memory utilization, provides memory protection, and helps implement virtual memory concepts. The TLB, a specialized cache within the MMU, speeds up this translation process. It stores recent translations of virtual memory addresses to physical addresses, allowing for quicker memory access when reusing them. Together, these components enhance the speed and efficiency of memory access during program execution, ensuring faster and more efficient processing in computer systems. The execution flow in systems begins at a given CPU, progresses through the cache(s) (e.g., L1/L2 caches and last-level cache), moves along the Interconnect, and ultimately arrives at the memory. Any response from the memory results in operations propagated the other way around. This pathway illustrates the fundamental architecture upon which computing processes are premised. With the current trend toward cloud computing, not only storage but also processing components such as the CPU, MMU, and interconnect may operate in the cloud as provisioned services. A particularly significant change is that the memory store itself may now take the form of cloud-based memory, where data is obtained from a network-based memory resource rather than locally attached dynamic random-access memory (DRAM). This shift magnifies both latency and security concerns.

At the heart of this flow lies the principle of coherency. Coherency is intrinsic to maintaining data consistency across diverse processing elements (PEs), also known as coherent managers. In a multiprocessor system, when different processors have private caches, multiple copies of the same memory location might exist in different caches. To ensure that all PEs have a consistent view of memory, their caches must be synchronized. This means that other processors immediately see a write by one processor to a cached shared memory location. This occurs through a Cache-Coherent-Interconnect (CCI), a subsystem primarily monitoring and orchestrating data transfer across the system's caches and processing elements. Upon a cache miss, the CCI broadcasts this request to all the coherent managers in the system. This broadcast, also known as a snoop, is to see if any cache has a copy of the data. If no one responds, the data is fetched from the backing memory. In conventional designs, this is main memory (DRAM), but in cloud memory systems the request propagates to the cloud-based memory across a network. Conversely, upon a response, the responder is committed to providing the updated data to the requesting cache-miss. That data can be sent directly to the requesting processor as a cache line (e.g., instruction cache line or a data cache line). Over the decades, many coherency protocol variants have been used (e.g., MESI, MOESI).

Traditional secure processing often has a problem: while encrypted in memory, data must be decrypted before being fed back to the processor. This conventional flow, CPU→Memory→CPU, exposes decrypted data in several vulnerable locations, including the Last-Level Cache (LLC) and the CCI. These exposure points create potential attack surfaces for malicious actors capable of probing or monitoring activity within the memory hierarchy. In cloud memory systems, the risk is heightened: data leaves the trusted hardware boundary, traverses network fabrics, and resides in memory resources not physically controlled by the processor's owner. As a result, decrypted data becomes particularly susceptible to interception, manipulation, or observation as it moves between the processor and remote cloud memory.

Another related limitation is that customers of cloud-based memory are typically constrained to using the encryption scheme offered by the cloud service provider. This restricts flexibility and control, as many customers prefer to use their own encryption algorithms to meet internal security, compliance, or performance requirements. The inability to employ custom encryption further amplifies security and trust concerns, particularly in environments where data confidentiality and sovereignty are paramount.

Therefore, there is a need to ensure that the exposure of decrypted data is limited within the cache hierarchy, the CCI, or during transmission to and from cloud memory, and to allow greater customer control over encryption schemes in order to provide stronger security guarantees against risks of interception, manipulation, or observation in such architectures.

### SUMMARY

Techniques are provided for computer processing that leverages cache line invalidation and cryptography at the cache coherency level. Specifically, a hardware agent (e.g., FPGA) may operate as a cache coherent manager with a CCI. Specifically, the hardware agent appears to the CCI as a typical cache, however the hardware agent can, as will be described in further detail below, take over control of providing decrypted data to a CPU for a physical address monitored by the hardware agent and encrypted data that is dirtied by the CPU for a physical address being monitored by the hardware agent.

In an embodiment, the hardware agent may monitor snoop requests issued by the CCI for data requested by a CPU. The snoop requests are issued because of cache misses (e.g., lower-level caches at the CPU and LLC) and are associated with a particular physical address. The hardware agent may send a snoop response to the CCI indicating that it has the cache line for the requested data even though it does not. The hardware agent may obtain an encrypted form of the requested data from memory and perform decryption using a decryption session key provided by a client device over a secure channel. The decryption session key may correspond to an encryption scheme chosen by a customer operating the client device. The decrypted data may then be provided by the hardware agent to the CPU via the CCI and caches.

By providing the decrypted data to the CPU, a cache line is refilled. For example, the cache line may be an instruction cache line or a data cache line. Each instruction cache line may include an initial set of instructions that are followed by an invalidate instruction and a branch instruction. In an embodiment, the invalidate and branch instructions are inserted during compilation on the client device. After the initial set of instructions of the instruction cache line are processed by the CPU, the CPU encounters the invalidate instruction. The invalidate instruction causes the caches to invalidate their instruction cache lines corresponding to the physical address. The invalidate instruction causes subsequent cache misses (e.g., on the next instruction fetch) forcing the loading of a next instruction cache line. The CPU then encounters the branch instruction. The branch instruction causes the CPU to start processing at the beginning of the next instruction cache line. As a result, the hardware agent can sequentially process all instruction cache lines to the CPU for the physical address.

Each data cache line may be the result of a load instruction in an instruction cache line. In an embodiment, the load instruction may be followed by an invalidate instruction. When the CPU encounters the invalidate instruction after the data cache line is filled, the data cache line can be invalidated in the caches. Alternatively, the hardware agent may monitor a data cache line that is refilled when it provides the data to the CPU. When the hardware agent monitors the data cache line, the hardware agent can send a command that causes the caches to invalidate their data cache lines.

Further, and when a data cache line is refilled, the data may be modified (i.e., dirtied) by the CPU. When the CPU wants to dirty data, it transitions from a shared state to an exclusive or modified state. The hardware agent may monitor this transition to ensure that it receives the dirty data before all coherent managers. The hardware agent may then encrypt the dirty data using an encryption session key received over the secure channel from the client device, where the encryption session key corresponds to the encryption scheme chosen by a customer operating the client device. The encrypted data may be transmitted from the hardware agent to memory for storage.

### BRIEF DESCRIPTION OF THE DRAWINGS

The description below refers to the accompanying drawings, of which:

FIG. 1 is an illustrative example of a system environment for computer processing that leverages cache line invalidation and data cryptography at the cache coherency level according to the one or more embodiments as described herein;

FIG. 2 illustrates a text section with inserted instructions that is generated during compilation according to the one or more embodiments as described herein;

FIG. 3 is an illustrative example of a hardware agent according to the one or more embodiments as described herein;

FIG. 4 is a flow diagram of a sequence of steps for hardware agent receiving snoop requests from the CCI and taking over control of obtaining requested data from memory according to the one or more embodiments as described herein;

FIG. 5 is a flow diagram of a sequence of steps for invalidating instruction cache lines according to the one or more embodiments as described herein;

FIG. 6 is a flow diagram of a sequence of steps for invalidating data cache lines according to the one or more embodiments as described herein; and

FIG. 7 is a flow diagram of a sequence of steps for the hardware agent taking control for writing dirty data to memory according to the one or more embodiments as described herein.

### DETAILED DESCRIPTION OF AN ILLUSTRATIVE EMBODIMENT

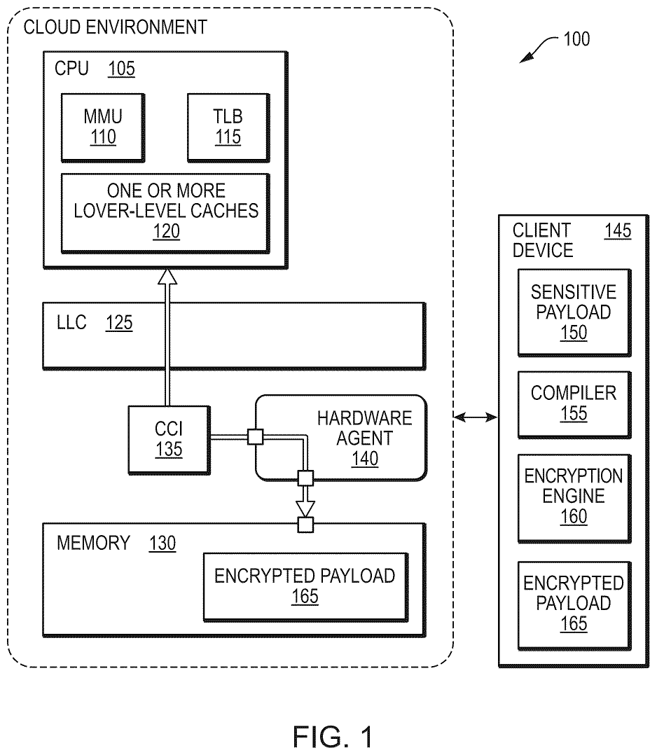

FIG. 1 is an illustrative example of a system environment for computer processing for leveraging cache line invalidation and computer data cryptography at the cache coherency level according to the one or more embodiments as described herein. As depicted in FIG. 1, particular devices are shown within a cloud environment, represented by the dashed box. However, it is expressly contemplated that only the memory 130 may reside in the cloud, while one or more of the other devices of system environment 100 may be on-premises.

System environment 100 includes a central processing unit (CPU) 105 that includes a memory-management unit (MMU) 110, a translation lookaside buffer (TLB) 115, and one or more lower-level caches 120. FIG. 1, includes one CPU 105 for simplicity and ease of understanding, but it should be understood that system environment 100 may include a plurality of different CPUs 105.

In an embodiment, the CPU 105 may execute one or more instructions or perform one or more operations. During execution of an instruction or performance of an operation, the CPU 105 may generate a memory access request corresponding to a virtual address (VA) referenced by the instruction or operation. The MMU 110 may access the TLB 115 to translate the VA to a corresponding physical address (PA).

The CPU 105 may use the PA to check the one or more lower-level caches 120 to determine whether the requested data is stored therein, wherein the requested data may correspond to an instruction cache line or a data cache line. The one or more lower-level caches 120 may include instruction caches configured to store instructions and data caches configured to store data values. Further, the one or more lower-level caches 120 may be configured as an L1 cache and/or an L2 cache. If the requested data is not found in the one or more lower-level caches 120, the CPU 105 may obtain the data from a last-level cache (LLC) 125 or from memory 130 via the cache coherency interconnect (CCI) 135 and hardware agent 140, as described below.

When there is a cache miss at the one or more lower-level caches 120, the PA may be used to perform a lookup in the LLC 125 for the requested data. If a cache miss also occurs at the LLC 125, the CCI 135 may be notified of the cache miss. In an embodiment, the CCI 135 is configured, as known by those skilled in the art, to maintain coherency among the plurality of caches. With conventional systems and techniques, and as described above, the cache misses cause the requested data to be obtained from the memory 130, at the location identified by the PA, via the CCI 135. For example, the requested data may be stored in encrypted form within the memory 130. However, in conventional systems and techniques, the requested data must be decrypted before being transmitted back to the CPU 105. Therefore, conventional systems and techniques expose the decrypted data to potential malicious actors at highly vulnerable locations, such as, but not limited to, the CCI 135 and LLC 125, and one or more lower-level caches 120.

As will be described in further detail below, the one or more embodiments overcome these deficiencies through the operation of the hardware agent 140 that monitors snoop requests from CCI 135 and through the way the encrypted data is generated using a compilation process at client device 145.

In an embodiment, client device 145 may be operated by a customer of a cloud service provider that manages and operates at least memory 130. Client device 145 may store sensitive payload data 150, which the customer wants to store on memory 130 (e.g., cloud memory) in an encrypted form. Client device 145 may also include compiler 155. Although FIG. 1 shows the compiler being internal to the client device 145, it is expressly contemplated that the compiler may be external to client device 145 and the client device 145 may, for example, access the external compiler over a network (not shown). The compiler 155 may generate assembly code that, when assembled and linked, results in executable instructions organized within a text section (e.g., a .text segment). Data values, including sensitive payload data 150, may be stored within a data section (e.g., a .data segment) that the execution instructions in the text section can access.

According to the one or more embodiments as described herein, the compiler 155 may insert one or more instructions into the text section of the assembly code during compilation. As will be described in further detail below in relation to the flow diagrams, the execution of the inserted instructions can cause instruction cache lines and data cache lines to be invalidated in the caches (e.g., lower-level caches 120 and LLC 125). By invalidating the cache lines in the manner described herein, the one or more embodiments provide increased security for sensitive data when compared to conventional systems and techniques.

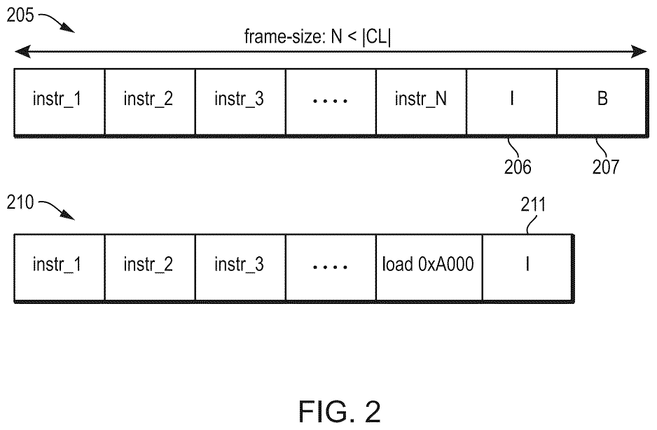

FIG. 2 illustrates a text section with inserted instructions that is generated during compilation according to the one or more embodiments as described herein. In computer architecture, a fixed cache line width refers to the predetermined size of a cache line (e.g., cache block), which defines the data transfer unit between the cache hierarchy and main memory. In the context of the present embodiments, let |CL| denote the fixed cache line width within the system architecture 100. The cache line width |CL| may be independent of whether the cache line stores instructions (e.g., an instruction cache line) or data values (e.g., a data cache line). A frame size N may also be defined as a fixed portion of the cache line, where N<|CL|−2, and where N represents the portion of the cache line used to store instruction content of an instruction cache line. When a cache miss occurs at the one or more lower-level caches 120 and the LLC 125, the data corresponding to the requested PA is not obtained individually. Instead, the entire cache line that includes the requested PA is obtained from memory 130 based on the cache line width |CL|. Accordingly, both the cache line width |CL|and the frame size N are fixed parameters.

According to the one or more embodiments as described herein, compiler 155 may, as part of the compilation process, insert an invalidate instruction and a branch instruction at every N−2 instructions of the text section 205 of the assembly code. For this example, let it be assumed that the text section 205 of the generated assembly code maps to VA 0xB000. As depicted in FIG. 2, the compiler 155 may insert an invalidate instruction 206 (e.g., [invalidate 0xB000]) and a branch instruction (e.g., [branch 0xB000]) 207 for virtual address 0xB000 at every N−2 instructions of the text section 205. As a result, each instruction cache line that is provided to CPU 105 from memory 130, by way of the hardware agent 140 as described below, will include an initial set of instructions followed by the invalidate and branch instructions. In an alternative embodiment, the invalidate and branch instructions may be inserted at a different interval of instructions. For example, the invalidate and branch instructions may be inserted at the end of every two cache lines, four cache lines, six cache lines, or any number of cache lines.

As will be described in further detail below in relation to the flow diagrams, the invalidate instruction in each instruction cache line causes each of the caches (e.g., lower-level caches 120 and LLC 125) to invalidate its instruction cache line corresponding to a PA (e.g., 0xC) that is mapped to the VA (e.g., 0xB). This will result in cache misses such that the hardware agent 140 can repeatedly obtain sequential instruction cache lines from memory 130 that corresponds to the PA. As will be described in further detail below in relation to the flow diagrams, the branch instruction in each instruction cache line causes the CPU 105 to process the beginning of the next instruction cache line that is obtained by the hardware agent 140 based on the cache misses caused by the invalidate instruction.

In an embodiment, compiler 155 may insert an invalidate instruction after every load instruction in text section 210 of the assembly code. As depicted in FIG. 2, text section 210 includes a load instruction 211 for the VA of 0xA000. According to the one or more embodiments as described herein, compiler 155 may identify the load instruction and insert a corresponding invalidate instruction for the VA after the load instruction. Therefore, each load instruction for a VA will include a subsequent invalidate instruction for that same VA. The result of a load instruction is a data cache line. As will be described in further detail below, the subsequent invalidate instruction ensures the caches invalidate the data cache line after the hardware agent 140 obtains the data (i.e., corresponding to the load instruction) from memory 130 and provides the data cache line to the CPU 105.

In an embodiment, the compiler 155 inserts the invalidate instruction for every load instruction before the compiler 155 inserts the invalidate and branch instructions for every N−2 instructions. Moreover, and as will be described in further detail below, the compiler 155 need not insert the invalidate instruction for every load instruction and, instead, the hardware agent 140 may provide an invalidate command to CCI 135 to ensure the caches invalidate the data cache line.

In an embodiment, the compiler 155 may divide the assembly code into chunks as part of the compilation process. After compilation, encryption engine 160 of client device 145 may utilize one or more particular encryption techniques to encrypt the assembly code and generate encrypted payload 165. Therefore, the encryption scheme is user selected and is not dictated by the cloud service provider that manages and operates memory 130. The encrypted payload 165 may then be provided over one or more networks (not shown) to memory 130 for storage as depicted in FIG. 1. As will be described in further detail below, the hardware agent 140 can monitor snoop requests from CCI 135 and take over control for obtaining and decrypting the encrypted payload 165 from memory 130. The hardware agent can then provide the decrypted data to CPU 105. As a result, the CCI 135 does not obtain decrypted data corresponding to the encrypted payload 165 stored in memory 130, as this role is now handled by the hardware agent 140.

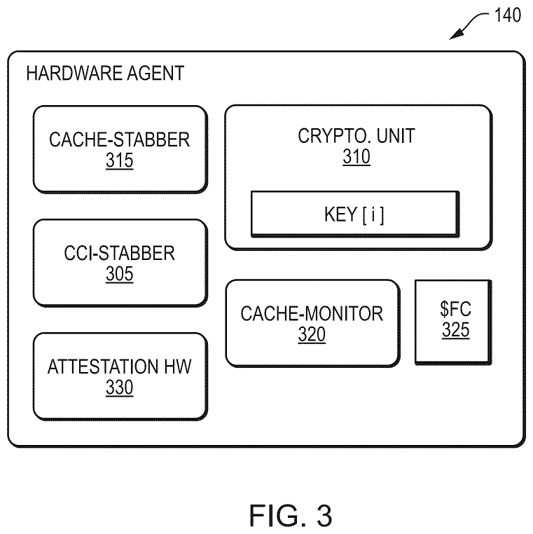

Referring back to FIG. 1, the system environment 100 also includes hardware agent 140. FIG. 3 is an illustrative example of hardware agent 140 according to the one or more embodiments as described herein. In an embodiment, the hardware agent 140 may be a field-programmable gate array (FPGA). In an embodiment, the hardware agent 140 may be programmed with the necessary components, which are depicted in FIG. 3, before the hardware agent 140 is operational and monitoring snoop requests from CCI 135 as will be described in further detail below. While in the operational mode, hardware agent 140 is coupled to (i.e., interfaces with) CCI 135 and memory 130 as depicted in FIG. 1. Although FIG. 1 depicts two distinct interfaces, it is expressly contemplated that the hardware agent 140 may communicate with the CCI 135 and memory 130 through a single interface. Further, the hardware agent 140 acts as a coherent manager with CCI 135. In an embodiment, the hardware agent 140 appears to be a cache device to the CCI 135.

As depicted in FIG. 3, the hardware agent 140 includes CCI-stabber 305 that allows the hardware agent 140 to interact with the CCI 135 and maintain the coherence protocol correctness used in the system environment 100. The crypto. unit 310 may store one or more keys (e.g., session keys) that can be used for encrypting and decrypting data. In an embodiment, the client device 145 may maintain a key pair (e.g., private key/public key pair) that are used for asymmetric handshaking with hardware agent 140 to establish a secure channel. Once the secure channel is established, the client device 145 may share a decryption session key and an encryption session key with the hardware agent 140.

The decryption session key and the encryption session key may be stored in a secure vault within the crypto. unit 310. As will be described in further detail below, the hardware agent 140 may obtain a portion of the encrypted payload 165 using frame counter 325. The crypto. unit 310 of the hardware agent 140 can use the decryption session key to decrypt the obtained portion of the encrypted payload 165 that is to be provided to CPU 105 as will be described in further detail below. The crypto. unit 310 can also use the encryption session key to encrypt data dirtied by the CPU 105 and that is provided to memory 130 for storage as will be described in further detail below.

As depicted in FIG. 3, the hardware agent 140 also includes attestation hardware 330 that can validate the authenticity of a snoop request by verifying that it originated from a trusted and attested CPU 105 identified in the snoop request metadata. Hardware agent 140 further includes cache-stabber 315. Cache-stabber 315 includes the functionality to allow the hardware agent to respond to snoop requests issued by the CCI 135 as will be described in further detail below. Moreover, the hardware agent 140 includes cache-monitor 320 that can, as will be described in further detail below, (1) determine when too much time has elapsed thereby indicating that the system 100 might be compromised, and (2) determine that the CPU 105 has transitioned to an exclusive or modified state such that the hardware agent 140 can issue a request for the dirty cache line in a shared state so that the hardware agent 140 receives the dirty data before any other coherent managers.

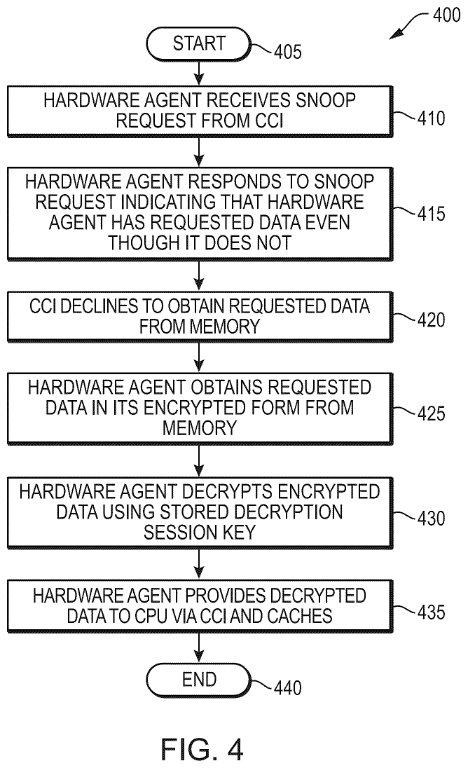

The flow diagrams of FIGS. 4 through 7 describe the operations of the devices (e.g., CPU 105, lower-level caches 120, LLC 125, CCI 135, memory 130, and hardware agent 140) at the cache coherency level after the encrypted payload 165 is stored in memory 130 and the hardware agent 140 of FIG. 3 is deployed and operational in system environment 100 by monitoring snoop requests.

The flow diagram of FIG. 4 is directed to the hardware agent 140 receiving snoop requests from the CCI 135 and taking over control of obtaining requested data from memory 130 according to the one or more embodiments as described herein. Specifically, and as will be described in further detail below, the hardware agent 140 may monitor or track one or more PAs (e.g., 0xC000) of interest, and the hardware agent 140 may receive the snoop request for the PA of interest from the CCI 135. The hardware agent 140 can indicate that it has a cache line associated with the PA of interest even though the hardware agent 140 does not. As a result, the hardware agent may take over control by obtaining the encrypted form of the requested data from memory, decrypting the data, and then providing the decrypted data to the CPU 105 via the CCI 135 and the caches (e.g., lower-level caches 120 and LLC 125).

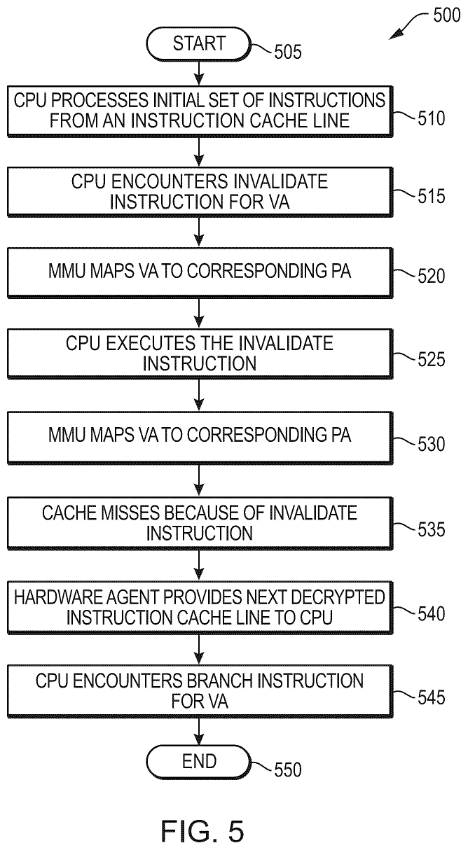

The flow diagram of FIG. 5 is directed to an illustrative embodiment when the hardware agent 140 returns an instruction cache line to the CPU 105 via the CCI 135 and caches (e.g., lower-level caches 120 and LLC 125). After the instruction cache line is provided, it is invalidated in the caches and the process repeats (i.e., loops) such that entire current epoch is sequentially processed through the hardware agent 140. The invalidation and loop is the result of the invalidate and branch instructions inserted during compilation as described above.

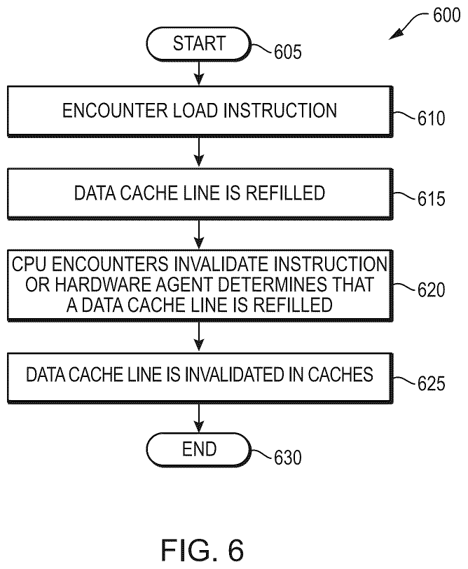

The flow diagram of FIG. 6 is directed to an illustrative embodiment when the hardware agent 140 returns a data cache line to the CPU 105 via the CCI 135 and caches (e.g., lower-level caches 120 and LLC 125). After the data cache line is provided, it is invalidated in the caches based on the invalidate instruction inserted during compilation or an invalidation command issued by the hardware agent 140.

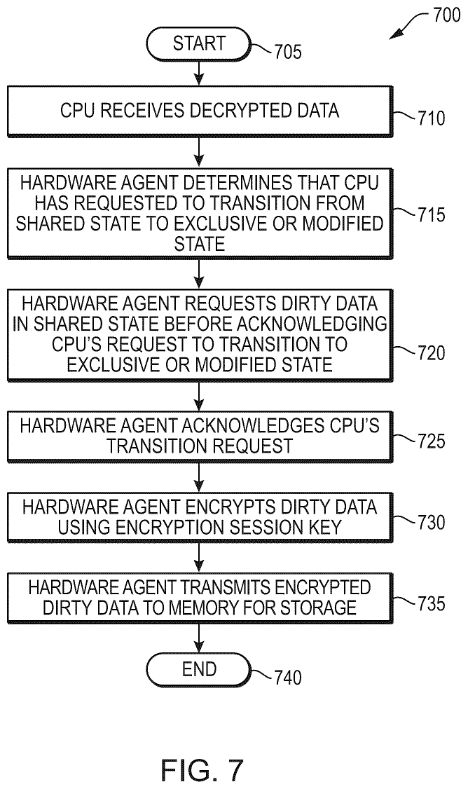

The flow diagram of FIG. 7 is directed to an illustrative embodiment when the CPU 105 transitions to an exclusive or modified state to dirty data, and the hardware agent 140 issues a request to receive, before any other coherent managers, the dirty data so that the hardware agent 140 can encrypt and write the encrypted dirty data to memory 130.

FIG. 4 is a flow diagram of a sequence of steps for hardware agent 140 receiving snoop requests from the CCI 135 and taking over control of obtaining requested data from memory 130 according to the one or more embodiments as described herein. Procedure 400 starts at step 405 and continues to step 410. At step 410, the hardware agent 140 receives a snoop request from CCI 135. As an illustrative example, let it be assumed that the CPU 105 executes an initial instruction fetch operation for VA 0xB000 based on its program counter. Further, for this example, let it be assumed that all instructions corresponding to the PA of 0xC000 have been invalidated (pre-invalidated) in lower-level caches 120 and LLC 125.

For this example, the MMU 110 accesses the TLB 115 to translate the VA 0xB000 to the corresponding PA 0xC000. As noted above, PA 0xC000 has been invalidated in lower-level caches 120 and LLC 125. As a result, there will be cache misses at lower-level caches 120 and LLC 125. Therefore, the CCI 135 receives a notification of the cache misses and sends a snoop request to all coherent managers requesting the cache line. Because the hardware agent 140 is a coherent manager to the CCI 135, the hardware agent 140 receives the snoop request associated with PA 0xC000. In an embodiment, the attestation hardware 330 may validate the authenticity of the snoop request.

The procedure continues from step 410 to step 415. At step 415, the hardware agent 140 responds to snoop request with a snoop response indicating that the hardware agent 140 has the requested data (e.g., cache line) even though it does not. Continuing with the example, let it be assumed that the hardware agent 140 is monitoring PA 0xC000. Therefore, the hardware agent 140 is concerned with those snoop requests that reference PA 0xC000, while the hardware agent 140 is not concerned with the snoop requests that reference other PAs. Because the received snoop request in this example references PA 0xC000, the hardware agent 140 informs the CCI 135 with a snoop response that it has that cache line even though it does not. In an embodiment, cache-stabber 315 generates and provides the snoop response to the CCI 135.

The procedure continues from step 415 to step 420. At step 420, the CCI 135 declines to obtain the requested data from memory 130 because of the snoop response. Because the CCI 135 knows from the snoop response that the hardware agent 140 has the cache line, the CCI 135 determines that it does not have to obtain the data from memory 135.

The procedure continues from step 420 to step 425. At step 425, the hardware agent 140 obtains the requested data in its encrypted form from memory at the location identified by the PA. For this example, let it be assumed that the $FC 325 is at its initial or starting value. Therefore, $FC 325 at its initial value can be utilized to obtain the first chunk of the encrypted payload 165 that corresponds to PA 0xC000.

The procedure continues from step 425 to step 430. At step 430, the hardware agent 140 decrypts the encrypted data using the decryption session key stored in the secure vault of crypto. unit 310 of the hardware agent 140. As previously explained, the decryption session key is provided by client device 145 to the hardware agent 140 over a secure channel.

The procedure continues from step 430 to step 435. At step 435, the hardware agent 140 provides the decrypted data (e.g., cache line) to CPU 105 by way of CCI 135, LLC 125, and lower-level caches 120. In an embodiment, the cache monitor 320 of hardware agent 140 can monitor the elapsed time after sending the decrypted data to the CPU 105. The cache monitor can determine that system environment 100 might be compromised (e.g., by a malicious attacker) when the elapsed time meets or exceeds a predefined threshold value without invalidation of the particular cache line. Specifically, if the hardware agent 140 determines that the particular cache line was invalidated within the threshold amount of time, the hardware agent 140 can determine that the system is not compromised. But if the invalidation has not occurred in the threshold amount of time, then the hardware agent 140 can determine that the system is compromised. In an embodiment, the predefined threshold value may be user-defined. Alternatively, the predefined threshold value may be determined by the hardware agent 140 based on the type and/or size of the decrypted data provided to the CPU 105. Procedure 400 then ends at step 440.

As such, the encrypted payload 165 is securely stored in memory 130 using an encryption scheme selected by the customer operating client device 145. The corresponding decryption session key is generated in accordance with the selected scheme, transmitted over a secure channel, and maintained in a secure vault of hardware agent 140. This architecture improves upon conventional cloud-based approaches in which encryption and decryption are often managed entirely by the cloud service provider, where data and keys commonly reside within the same provider infrastructure and a single encryption scheme is applied across multiple customers.

In contrast, the embodiments described herein enhance both flexibility and security by enabling each customer to employ a customer-selected encryption scheme and by ensuring that encryption keys are not stored with the encrypted data. For example, the encrypted payload 165 resides in memory 150 while the decryption key is retained in the secure vault of hardware agent 140. Accordingly, the one or more embodiments as described herein provide a technical improvement in computer data protection systems by reducing the risk of key exposure and improving the confidentiality of data stored in distributed computing environments. In other words, the embodiments described herein improve the existing technological field of data cryptography.

As noted above, the result of step 435 is the refilling of an instruction cache line or a data line into LLC 125 and caches 120. Because the data is decrypted during the transfer from hardware agent 140 to CPU 105, the refilled cache line contains decrypted data rather than the encrypted form stored in memory 130. As a result, LLC 125 and CCI 135, for example, become more susceptible to unauthorized access targeting the exposed data. The one or more embodiments as described herein address these deficiencies and provide an improvement over existing conventional systems as will be described in further detail below in relation to the flow diagrams of FIGS. 5 and 6.

FIG. 5 is a flow diagram of a sequence of steps for invalidating instruction cache lines according to the one or more embodiments as described herein. The procedure 500 starts at step 505 and continues to step 510. At step 510, the CPU 105 processes an initial set of instructions from an instruction cache line. For example, the initial instructions may include load or store instructions that access memory, arithmetic or logical instructions that operate on registers, and control-flow instructions that (e.g., jumps, calls, or branches) that alter the sequence of execution.

As an illustrative example, let it be assumed that the instruction cache line is obtained by the hardware agent 140 using $FC 325. For this example, the VA 0xB000 maps to PA 0xC000. Further, and as previously explained, in an embodiment each instruction cache line will have an invalidate instruction (e.g., invalidate [0xB000]) and branch instruction (e.g., branch [0xB000]) at every N−2 instructions based on the compilation process executed on client device 145.

Therefore, each instruction cache line will have an initial set of instructions followed by invalidate and branch instructions. As such, and at step 510, the CPU 105 may process the initial set of instructions that precede the invalidate and branch instructions.

The procedure continues from step 510 to step 515. At step 515, the CPU 105 encounters an invalidate instruction for a VA in the instruction cache line. Continuing with the example, and after the CPU 105 processes the initial instructions of the instruction cache line, the CPU 105 encounters the invalidate 0xB000 instruction. The procedure continues from step 515 to step 520. At step 520, the MMU maps the VA to a corresponding PA. For this example, the MMU 110 accesses the TLB 115 to translate VA 0xB000 to the corresponding PA 0xC000.

The procedure continues from step 520 to step 525. At step 525, the CPU 105 executes the invalidate instruction. In this example, the execution of the invalidate instruction causes the lower-level caches 120 to invalidate its instruction cache line corresponding to PA 0xC000. In an embodiment, the invalidate instruction causes the LLC 125 to invalidate its instruction cache lines corresponding to PA 0xC000.

The procedure continues from step 525 to step 530. At step 530, the MMU maps the VA to a corresponding PA. For this example, the CPU updates its program counter after encountering the invalidate instruction to process the next instruction in the cache line. Based on the updated program counter, the MMU 110 accesses the TLB 115 to translate the VA 0xB000 to the corresponding PA 0xC000. The procedure continues from step 530 to step 535. At step 535, there are cache misses for the PA because of the invalidate instruction. Continuing with the example, there are cache misses at lower-level caches 120 and LLC 125.

The procedure continues from step 535 to step 540. At step 540, the hardware agent 140 provides the next decrypted instruction cache line to the CPU 105. Specifically, and as described above in relation to FIG. 4, the hardware agent 140 receives the snoop request from the CCI 135 because of the cache misses. The hardware agent 140 may then respond that it has the instruction cache line even though it does not. The hardware agent 140 may then obtain the next instruction cache line using the next instruction frame of $FC+N. The next instruction cache line can then be decrypted and provided to the CPU 105 as described above in relation to FIG. 4.

The procedure continues from step 540 to step 545. At step 545, the CPU 105 encounters the branch instruction for the VA in the instruction cache line. Continuing with the example, the CPU 105 updates its program counter and encounters branch [0xB000]. The branch instruction causes the CPU 105 to execute the first instruction in the next instruction cache line provided to the CPU 105 at step 540. In other words, the branch instruction causes the program counter to be reset so that the instructions of the next instruction cache line can be processed sequentially from the beginning of the next instruction cache line to the end of the next instruction cache line.

Therefore, the invalidate instruction and the branch instruction in each instruction cache line causes the hardware agent 140 to obtain, decrypt, and provide sequential instruction cache lines to the CPU 105 using the local updated frame counter. Thus, this loop is repeated until the frame counter marks the completion of a current epoch or until all compiled epochs of the encrypted payload 165 are provided. Procedure 500 then ends at step 550.

Accordingly, the procedure of FIG. 5 ensures that the instruction cache lines are not retained in cache and are instead invalidated after processing by the CPU 105. Additionally, the branch instruction ensures that the procedure 500 is repeated so the instructions of the instruction cache lines are sequentially processed and invalidated in the caches, thereby minimizing the time the decrypted data stays in cache (e.g., low-level caches 120 and LLC 125) when compared to conventional systems and techniques. By minimizing the exposure of instruction cache lines in the caches as described herein (e.g., through insertion of invalidate and branching instructions during compilation), the one or more embodiments provide an improvement to existing data cryptography technologies. Because the security of the data is enhanced through the procedure of FIG. 5, the one or more embodiments further improve the security of the overall computer architecture (e.g., system environment 100). Accordingly, the embodiments described herein improve the functioning of the computer itself, including its underlying architectural security.

FIG. 6 is a flow diagram of a sequence of steps for invalidating data cache lines according to the one or more embodiments as described herein. Procedure 600 starts at step 605 and continues to step 610. At step 610, the CPU 105 encounters a load instruction in the initial set of instructions of an instruction cache line. As explained above in relation to FIG. 5, each instruction cache line will have an initial set of instructions followed by invalidate and branch instructions. It is in the initial instructions that the CPU 105 encounters the load instruction. For this example, let it be assumed that the load instruction is load 0xA000.

The procedure continues from step 610 to step 615. At step 615, a data cache line is refilled. Continuing with the example, the MMU maps VA 0xA000 to a corresponding PA. For this example, the MMU 110 accesses the TLB 115 to translate the VA 0xA000 to the corresponding PA 0xD000. Further, and in this example, let it be assumed that prior to translation the caches have been invalidated for the PA 0xD000. Therefore, this results in cache misses and the hardware agent 140 obtaining, decrypting, and providing the data cache line to CPU 105 in a similar manner as described above in relation to FIG. 4. Therefore, the data cache line is refilled in lower-level caches 120 and LLC 125.

The procedure continues from step 615 to step 620. At step 620, the CPU 105 encounters the invalidate instruction (e.g., invalidate instruction that is after the load instruction) or the hardware agent 140 determines that a data cache line was refilled. As previously explained in relation to FIG. 2, the compiler 155 may insert an invalidate instruction for a load instruction. Alternatively, the hardware agent 140 may determine that a data cache line is being refilled when it provides the data cache line to the CPU 105 as described above in relation to FIG. 4.

The procedure continues from step 620 to step 625. At step 625, the data cache line is invalidated in the caches (e.g., lower-level caches 120 and LLC 125). Specifically, and in a similar manner as described in relation to FIG. 5, the CPU 105 may invalidate the data cache lines in the lower-level caches 120 and the LLC 125 based on execution of the invalidate instruction. Alternatively, and before the hardware agent 140 obtains the next instruction cache line using a next frame count, the hardware agent 140 may issue an invalidate command for PA 0xD000 to the CCI 135 on a cache coherence channel. As a result, the data cache lines of the LLC 125 and lower-level caches 120 may be invalidated.

Therefore, regardless of whether the invalidation is based on the instruction inserted during compilation or based on the monitoring by the hardware agent 140, the caches invalidate their data cache lines corresponding to PA 0xD000. The procedure then ends at step 630.

Therefore, the procedure of FIG. 6 ensures that the data cache lines are not retained in cache and are instead invalidated. By minimizing the exposure of data cache lines in the caches as described herein, the one or more embodiments provide an improvement to existing data cryptography technologies. Because the security of the data is enhanced through the procedure of FIG. 6, the one or more embodiments further improve the security of the overall computer architecture (e.g., system environment 100). Accordingly, the embodiments described herein improve the functioning of the computer itself, including its underlying architectural security.

FIG. 7 is a flow diagram of a sequence of steps for the hardware agent taking control for writing dirty data to memory according to the one or more embodiments as described herein. Procedure 700 starts at step 705 and continues to step 710. At step 710, the CPU 105 receives decrypted data. For example, the CPU 105 may receive decrypted data in a similar manner as described above in relation to FIG. 5 from the hardware agent 140.

The procedure continues from step 710 to step 715. At step 715, the hardware agent 140 determines that the CPU 105 has requested to transition from a shared state to an exclusive or modified state. In an embodiment, when the CPU 105 transitions a data cache line from a shared state to an exclusive or modified state to modify (i.e., dirty) the data, it notifies the CCI 135 with a request, for example. This allows the CCI 135 to send a snoop request to the other coherent managers indicating that if they hold a data cache line corresponding to the physical address of the data to be dirtied, they are to invalidate that data cache line. The cache-monitor 320 of the hardware agent 140 may monitor the snoop requests to identify this type of snoop request indicating that the CPU 105 is transitioning to an exclusive or modified state.

The procedure continues from step 715 to step 720. At step 720, the hardware agent 140 requests the dirty data in a shared state before acknowledging CPU's request to transition to exclusive or modified state. Specifically, the determination by the hardware agent 140 that the CPU is transitioning to the exclusive or modified state triggers the hardware agent 140 to immediately request the dirtied cache line to be returned to the shared state. The procedure continues from step 720 to step 725. At step 725, the hardware agent 140 acknowledges the CPU's transition request.

By requesting the dirty data in the shared state before providing its acknowledgement, the hardware agent 140 ensures that it will receive the dirty cache line before any other coherent managers. Specifically, acknowledgments are required by all coherent managers before the CPU 105 transitions from the shared state to the exclusive or modified state.

After the acknowledgments are received, the CPU 105 can transition to the exclusive or modified state and modify the data to complete a store instruction. After the data is modified (i.e., dirtied), the cache line corresponding to the dirty data transitions to the shared state and the dirty data (i.e., dirty cache line) is transmitted to the hardware agent 140. With conventional systems and techniques, it is at the point in time after all acknowledgments are received that a coherent manager will typically request a shared state of data. According to the one or more embodiments as described herein, the hardware agent 140 requests the dirty data cache line in a shared state before providing its acknowledgment, thereby ensuring that the hardware agent 140 will be the first coherent manager to request the shared state of the dirty cache line since each other coherent manager will not make such a request until after it provides its acknowledgement. In an embodiment, the hardware agent 140 may determine that the system is compromised if a different coherent manager requests the dirty data before the hardware agent 140.

By requesting the shared state, the dirty cache line (i.e., cache line with corresponding dirty data), and its ownership, can be provided from the CPU 105 to the hardware agent 140 via the CCI 135. After ownership is transferred, the hardware agent 140 is responsible for the dirty cache line. With conventional systems and techniques, when a cache receives a dirty cache line, the data of the dirty cache line typically gets written to memory 130 after it is evicted from the cache. However, the hardware agent 140 is not a typical cache and instead only appears as a typical cache to the CCI 135. Therefore, the hardware agent 140 can take over control of the dirty data according to the one or more embodiments as described herein.

The procedure continues from step 725 to step 730. At step 730, the hardware agent 140 encrypts the dirty data using the encryption session key. As explained previously, the encryption session key is received from the client device 145 over a secure channel and based on the user selected encryption scheme. The procedure continues from step 730 to step 735. At step 735, the hardware agent 140 transmits the encrypted dirty data to memory 130 for storage. The procedure then ends at 740.

As explained above, the embodiments described herein enhance both flexibility and security by enabling each customer to employ a customer-selected encryption scheme and by ensuring that encryption keys are not stored with the encrypted data. For example, the encrypted payload 165 resides in memory while the encrypt key is retained in the secure vault of hardware agent 140. Accordingly, the one or more embodiments as described herein provide a technical improvement in computer data protection systems by reducing the risk of key exposure and improving the confidentiality of data stored in distributed computing environments. In other words, the embodiments described herein improve the existing technological field of data cryptography.

It should be understood that a wide variety of adaptations and modifications may be made to the techniques. For example, the steps of the flow diagrams as described herein may be performed sequentially, in parallel, or in one or more varied orders. In general, functionality may be implemented in software, hardware or various combinations thereof. Software implementations may include electronic device-executable instructions (e.g., computer-executable instructions) stored in a non-transitory electronic device-readable medium (e.g., a non-transitory computer-readable medium), such as a volatile memory, a persistent storage device, or other tangible medium. Additionally, it should be understood that the term user and customer may be used interchangeably. Hardware implementations may include logic circuits, application specific integrated circuits, and/or other types of hardware components. Further, combined software/hardware implementations may include both electronic device-executable instructions stored in a non-transitory electronic device-readable medium, as well as one or more hardware components. Above all, it should be understood that the above description is meant to be taken only by way of example.

What is claimed is:

1. A system for computer processing that leverages cache line invalidation and data cryptography at the cache coherency level, the system comprising:
a memory;
a processor coupled to a plurality of caches;
a cache coherent interconnect connected to the processor and the memory, the cache coherent interconnect configured to maintain coherency between the plurality of caches; and
a hardware agent coupled to the cache coherent interconnect as a coherent manager, the hardware agent configured to:
receive, from the cache coherent interconnect, a snoop request for an instruction cache line for a current cache block, wherein the instruction cache line is stored in the memory as encrypted data and the snoop request is based on an original request initiated at the processor;
transmit, to the cache coherent interconnect, a snoop response indicating that the hardware agent stores the instruction cache line for the current cache block;
obtain the encrypted data from the memory;
decrypt, using a key stored at the hardware agent, the encrypted data to generate a decrypted instruction cache line; and
transmit the decrypted instruction cache line to the processor by way of the cache coherent interconnect and plurality of caches, wherein the decrypted instruction cache line includes an invalidate instruction for the current cache block followed by a branch instruction for the current cache block.

2. The system of claim 1, wherein the decrypted instruction cache line includes a load instruction for a particular cache block,, wherein the load instruction for the particular cache block is followed by an invalidate instruction for the particular cache block.

3. The system of claim 1, wherein the hardware agent is further configured to:
identify a load instruction for a data cache block in the decrypted instruction cache line;
provide a decrypted data cache block to the processor;
issue an invalidation command to the plurality of caches in response to identifying the load instruction and providing the decrypted data cache block, wherein the invalidation command causes each of the plurality of caches to invalidate the data cache block stored within each of the plurality of caches.

4. The system of claim 3, wherein the invalidation command is issued before the hardware agent obtains a next instruction cache line.

5. The system of claim 1, further comprising:
a compiler configured to compile code to generate compiled code that includes a plurality of chunks, and each chunk includes N number of instructions and occupies a single cache line, wherein the N number of instructions include N−2 initial instructions, an invalidate instruction, and a branch instruction;
an encryption engine configured to encrypt the compiled code to generate encrypted compiled code; and
the memory configured to store the encrypted compiled code, wherein the encrypted data is a particular chunk of the encrypted compiled code.

6. The system of claim 1, wherein the hardware agent is further configured to:
determine that the processor is transitioning from a shared state to an exclusive state or a modified state to modify a data block;
in response to determining that the processor is transitioning from the shared state to the exclusive state or the modified state, send a request to the processor by way of the cache coherent interconnect to transition the data block back to the shared state;
send acknowledgment to all coherent managers that it has received the processor's request to transition from the shared state to the exclusive state to the modified state;
receive, after sending the acknowledgement, the modified data block;
encrypt the modified data block to generate an encrypted data block;
transmit the encrypted data block to the memory for storage.

7. The system of claim 1, wherein the hardware agent is further configured to:
monitor an elapsed time after the decrypted data leaves the hardware agent; and
when the elapsed time exceeds a predetermined threshold without invalidation of the decrypted instruction cache, determine that the system has been compromised.

8. A method for computer processing that leverages cache line invalidation and data cryptography at the cache coherency level, the method comprising:
maintaining, by a cache coherent interconnect, cache coherency between a plurality of caches coupled to a processor;
receiving, by a hardware agent coupled to the cache coherent interconnect and acting as a coherent managers, a snoop request for an instruction cache line for a current cache block, wherein the instruction cache line is stored in the memory as encrypted data and the snoop request is based on an original request initiated at the processor;
transmitting, from the hardware agent and to the cache coherent interconnect, a snoop response indicating that the hardware agent stores the instruction cache line for the current cache block;
obtaining, by the hardware agent, the encrypted data from a memory;
decrypting, by the hardware agent using a key stored at the hardware agent, the encrypted data to generate a decrypted instruction cache line;
transmitting, by the hardware agent, the decrypted instruction cache line to the processor by way of the cache coherent interconnect and plurality of caches, wherein the decrypted instruction cache line includes an invalidate instruction for the current cache block followed by a branch instruction for the current cache block.

9. The method of claim 8, wherein the decrypted instruction cache line includes a load instruction for a particular cache block, wherein the load instruction for the particular cache block is followed by an invalidate instruction for the particular cache block.

10. The method of claim 8, further comprising:
identifying, by the hardware agent, a load instruction for a data cache block in the decrypted instruction cache line;
providing, by the hardware agent, a decrypted data cache block to the processor;
issuing, by the hardware agent, an invalidation command to the plurality of caches in response to identifying the load instruction and providing the decrypted data cache block, wherein the invalidation command causes each of the plurality of caches to invalidate the data cache block stored within each of the plurality of caches.

11. The method of claim 10, wherein the invalidation command is issued before the hardware agent obtains a next instruction cache line.

12. The method of claim 8, further comprising:
compiling, by a compiler, code to generate compiled code that includes a plurality of chunks, and each chunk includes N number of instructions and occupies a single cache line, wherein the N number of instructions include N−2 initial instructions, an invalidate instruction, and a branch instruction;
encrypting, by an encryption engine, the compiled code to generate encrypted compiled code;
storing, at the memory, the encrypted compiled code, wherein the encrypted data is a particular chunk of the encrypted compiled code.

13. The method of claim 8, further comprising:
determining, by the hardware agent, that the processor has is transitioning from a shared state to an exclusive state or a modified state to modify a data block;
sending, by the hardware agent, a request to the processor by way of the cache coherent interconnect to transition the data block back to the shared state in response determining that the processor has modified the data block;
sending, by the hardware agent, an acknowledgment to all coherent managers that it has received the processor's request to transition from the shared state to the exclusive state to the modified state;
receiving, by the hardware agent and after sending the acknowledgment, the modified data block as it transitions back to shared state;
encrypting, by the hardware agent, the modified data block to generate an encrypted data block;
transmitting, by the hardware agent, the encrypted data block to the memory for storage.

14. The method of claim 8, further comprising:
monitoring, by the hardware agent, an elapsed time after the decrypted data leaves the hardware agent; and
determining, by the hardware gent that the system has been compromised when the elapsed time exceeds a predetermined threshold without invalidation of the decrypted instruction cache line.

15. A system for computer data cryptography at the cache coherency level, the system comprising:
a memory;
a processor coupled to a plurality of caches;
a cache coherent interconnect connected to the processor and the memory, the cache coherent interconnect configured to maintain coherency between the plurality of caches; and
a hardware agent coupled to the cache coherent interconnect as a coherent manager, the hardware agent configured to:
receives a snoop request for requested data from the cache coherent interconnect, wherein the requested data is stored at a physical address of the memory that is being monitored by the hardware agent and the requested data is stored as encrypted data at the physical address;
transmit, to the cache coherent interconnect, a snoop response indicating that the hardware agent stores the requested data even though the hardware agent does not store the data;
obtain the encrypted data from the physical address of the memory;
decrypt, using a key stored at the hardware agent, the encrypted data to generate decrypted data; and
transmit the decrypted data to the processor by way of the cache coherent interconnect and plurality of caches, wherein the decrypted data is returned to the processor as one or more cache lines and the one or more cache lines are invalidated in the plurality of caches before the hardware agent provides next decrypted data to the processor in the form of one or more other cache lines.

16. The system of claim 15, wherein the processor is further configured to execute an invalidate instruction in the decrypted data that is an instruction cache line to invalidate the instruction cache line in the plurality of caches.

17. The system of claim 16, wherein the processor is further configured to obtain, from the hardware agent, a next instruction cache line after executing the invalidate instruction.

18. The system of claim 17, wherein
the processor is further configured to execute a branch instruction in the decrypted data that is the instruction cache line to execute a first instruction in the next instruction cache line.

19. The system of claim 15, wherein the decrypted data is a data cache line, and wherein the processor is further configured to execute a data invalidation instruction that invalidates the data cache line from the plurality of caches.

20. The system of claim 15, wherein the decrypted data is a data cache line, and wherein the hardware agent is further configured to transmit an invalidate command, after providing the decrypted data to the processor, that invalidates the data cache line from the plurality of caches using a coherence channel.
